(19) United States
(12) Patent Application Publication
(10) Pub. No.: US 2017/0120386 A1
(43) Pub. Date: May 4, 2017

(54) ALUMINUM ALLOY PRODUCTS, AND METHODS OF MAKING THE SAME

(71) Applicant: ARCONIC INC., Pittsburgh, PA (US)

(72) Inventors: Jen C. Lin, Export, PA (US); Lynnette M. Karabin, Ruffs Dale, PA (US); Cagatay Yanar, Pittsburgh, PA (US); David W. Heard, Pittsburgh, PA (US)

(21) Appl. No.: 15/366,691

(22) Filed: Dec. 1, 2016

Related U.S. Application Data
(63) Continuation of application No. PCT/US2016/022135, filed on Mar. 11, 2016.
(60) Provisional application No. 62/132,471, filed on Mar. 12, 2015.

(51) Int. Cl. B23K 26/342; C22C 21/14; B33Y 10/00; B22F 7/00; B23K 26/00; B23K 15/00; B22F 3/105; C22C 21/16; B33Y 70/00

(52) U.S. Cl. CPC B23K 26/342; C22C 21/16; C22C 21/14; B33Y 10/00; B33Y 70/00; B23K 26/0006; B23K 15/0086; B23K 15/0093; B22F 3/1055; B22F 7/008; B23K 2203/52

(57) ABSTRACT

The present disclosure relates to aluminum-based products having 1-30 vol. % of a ceramic phase. The aluminum alloy products may be produced via additive manufacturing techniques to facilitate production of the aluminum-based products having the 1-30 vol. % of the ceramic phase.

### CROSS-REFERENCE TO RELATED APPLICATIONS

This patent application is a continuation of International Patent Application No. PCT/US2016/022135 filed Mar. 11, 2016, entitled “ALUMINUM ALLOY PRODUCTS, AND METHODS OF MAKING THE SAME”, which claims the benefit of priority of U.S. Provisional Patent Application No. 62/132,471, filed Mar. 12, 2015, each of which is incorporated herein by reference in its entirety.

### BACKGROUND

Aluminum alloy products are generally produced via either shape casting or wrought processes. Shape casting generally involves casting a molten aluminum alloy into its final form, such as via pressure-die, permanent mold, green- and dry-sand, investment, and plaster casting. Wrought products are generally produced by casting a molten aluminum alloy into ingot or billet. The ingot or billet is generally further hot worked, sometimes with cold work, to produce its final form.

### SUMMARY OF THE INVENTION

Broadly, the present disclosure relates to aluminum-based products (e.g., aluminum alloy products) having a high volume percent (e.g., 1-30 vol. %) of at least one ceramic phase included therein. Such aluminum-based products may be produced via additive manufacturing. The high volume of ceramic phase may facilitate improved properties, such as improved stiffness and/or improved retention of strength at high temperature.

### BRIEF DESCRIPTION OF THE DRAWINGS

FIG. 1 is a schematic, cross-sectional view of an additively manufactured product (100) having a generally homogenous microstructure.

FIG. 2 is a schematic, cross-sectional views of an additively manufactured product produced from a single powder and having a first region (200) comprising an aluminum alloy and a second region (300) comprising a ceramic phase.

FIGS. 3a-3f are schematic, cross-sectional views of additively manufactured products having a first region (400) and a second region (500) different than the first region, where the first region is produced via a metal powder and the second region is produced via a ceramic-metal powder or a ceramic powder.

FIG. 4 is a flow chart illustrating some potential processing operations that may be completed relative to an additively manufactured aluminum alloy product. Although the dissolving (20), working (30), and precipitating (40) steps are illustrated as being in series, the steps may be completed in any applicable order.

FIG. 5a is a schematic view of one embodiment of using electron beam additive manufacturing to produce an aluminum alloy body.

FIG. 5b illustrates one embodiment of a wire useful with the electron beam embodiment of FIG. 5a, the wire having an outer tube portion and a volume of particles contained within the outer tube portion.

FIGS. 6a and 6b are SEM photographs of the atomized powder of Example 1, displaying TiB₂ particles encapsulated within a metal particle; the TiB₂ is homogenously distributed within the AA2519 matrix of the metal particle.

FIG. 7a-7c illustrates the optical metallography of the as-built AM component of Example 1 in the (a) XY plane, (b) YZ plane, and (c) XZ plane.

### DETAILED DESCRIPTION

As noted above, the present disclosure broadly relates to aluminum-based products (e.g., aluminum alloy products) having a high volume percent (e.g., 1-30 vol. %) of at least one ceramic phase included therein. Such aluminum-based products may be produced via additive manufacturing. The high volume of ceramic phase may facilitate improved properties, such as improved stiffness and/or improved retention of strength at high temperature.

The new aluminum alloy products are generally produced via a method that facilitates selective heating of powders to temperatures above the liquidus temperature of the particular aluminum material (the metallic aluminum or the aluminum alloy) to be formed, thereby forming a molten pool followed by rapid solidification of the molten pool. The rapid solidification facilitates maintaining various alloying elements in solid solution with aluminum. In one embodiment, the new aluminum alloy products are produced via additive manufacturing techniques.

As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The aluminum alloy products described herein may be manufactured via any appropriate additive manufacturing technique described in this ASTM standard, such as binder jetting, directed energy deposition, material extrusion, material jetting, powder bed fusion, or sheet lamination, among others. In one embodiment, an additive manufacturing process includes depositing successive layers of one or more powders and then selectively melting and/or sintering the powders to create, layer-by-layer, an aluminum alloy product. In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany). Additive manufacturing techniques may facilitate the selective heating of powders above the liquidus temperature of the particular aluminum alloy, thereby forming a molten pool followed by rapid solidification of the molten pool.

In one embodiment, a method comprises (a) dispersing a powder in a bed, (b) selectively heating a portion of the powder (e.g., via a laser) to a temperature above the liquidus temperature of the particular aluminum alloy to be formed, (c) forming a molten pool and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the aluminum alloy product is completed.

Due to the fabrication technique and the powders used in the processing, the final aluminum alloy products may realize a density close to the theoretical 100% density. In one embodiment, a final aluminum alloy product realizes a density within 98% of the product's theoretical density. In another embodiment, a final aluminum alloy product realizes a density within 98.5% of the product's theoretical density. In yet another embodiment, a final aluminum alloy product realizes a density within 99.0% of the product's theoretical density. In another embodiment, a final aluminum alloy product realizes a density within 99.5% of the product's theoretical density. In yet another embodiment, a final aluminum alloy product realizes a density within 99.7%, or higher, of the product's theoretical density.

As used herein, “powder” means a material comprising particles suited to produce an aluminum alloy product via additive manufacturing. In one embodiment, a powder includes metal particles. In one embodiment, a powder includes ceramic particles. In one embodiment, a powder includes ceramic particles and metal particles. In one embodiment, a powder includes ceramic-metal particles, optionally with separate ceramic particles and/or metal particles. In any of these embodiments, the powder may optionally include other particles, as defined below.

As used herein, “ceramic” means a material comprising at least one of the following compounds: TiB₂, TiC, SiC, Al₂O₃, BC, BN, and Si₃N₄. As used herein, a “ceramic particle” is a particle consisting essentially of a ceramic.

As used herein, “metal particle” means any particle, that is not a ceramic particle, as defined above, and having at least one metal. In one embodiment, a metal particle consists essentially of metallic aluminum. In another embodiment, a metal particle consists essentially of an aluminum alloy.

As used herein, “metallic aluminum” means a material comprising at least 99.00 wt. % Al. Examples of metallic aluminum materials include the 1xxx aluminum compositions, as defined by the Aluminum Association document “International Alloy Designations and Chemical Composition Limits for Wrought Aluminum and Wrought Aluminum Alloys” (2009) (a.k.a., the “Teal Sheets”), incorporated herein by reference in its entirety, and the 1xx aluminum casting and ingot compositions, as defined by the Aluminum Association document “Designations and Chemical Composition Limits for Aluminum Alloys in the Form of Castings and Ingot” (2009) (a.k.a., “the Pink Sheets”), incorporated herein by reference in its entirety.

As used herein, an “aluminum alloy” means an alloy having aluminum as the predominate element and at least one other element in solid solution with the aluminum. Examples of aluminum alloys include the 2xxx, 3xxx, 4xxx, 5xxx, 6xxx, 7xxx, and 8xxx aluminum alloys, as defined by the Teal Sheets, and the 2xx, 3xx, 4xx, 5xx, 7xx, 8xx and 9xx aluminum casting and ingot alloys, as defined by the Pink Sheets.

In one embodiment, a metal particle consists of a composition falling within the scope of a 1xxx aluminum alloy. As used herein, a “1xxx aluminum alloy” is an aluminum alloy comprising at least 99.00 wt. % Al, as defined by the Teal Sheets, optionally comprising tolerable levels of oxygen (e.g., from about 0.01 to 0.20 wt. % O) therein due to normal additive manufacturing processes. The “1xxx aluminum alloy” compositions include the 1xx alloy compositions of the Pink Sheets. The term “1xxx aluminum alloy” includes pure aluminum products (e.g., 99.99% Al products). As used herein, the term “1xxx aluminum alloy” only refers to the composition and not any associated processing, i.e., as used herein a 1xxx aluminum alloy product does not need to be a wrought product to be considered a 1xxx aluminum alloy composition/product described herein,

In one embodiment, a metal particle consists of a composition falling within the scope of a 2xxx aluminum alloy, as defined in the Teal Sheets. A 2xxx aluminum alloy is an aluminum alloy comprising copper (Cu) as the predominate alloying ingredient, except for aluminum, optionally comprising tolerable levels of oxygen (e.g., from about 0.01 to 0.20 wt. % O) therein due to normal additive manufacturing processes. The 2xxx aluminum alloy compositions include the 2xx alloy compositions of the Pink Sheets. Also, as used herein, the term “2xxx aluminum alloy” only refers to the composition and not any associated processing, i.e., as used herein a 2xxx aluminum alloy product does not need to be a wrought product to be considered a 2xxx aluminum alloy composition/product described herein.

In one embodiment, a metal particle consists of a composition falling within the scope of a 3xxx aluminum alloy, as defined in the Teal Sheets. A 3xxx aluminum alloy is an aluminum alloy comprising manganese (Mn) as the predominate alloying ingredient, except for aluminum, optionally comprising tolerable levels of oxygen (e.g., from about 0.01 to 0.20 wt. % O) therein due to normal additive manufacturing processes. Also, as used herein, the term “3xxx aluminum alloy” only refers to the composition and not any associated processing, i.e., as used herein a 3xxx aluminum alloy product does not need to be a wrought product to be considered a 3xxx aluminum alloy composition/product described herein.

In one embodiment, a metal particle consists of a composition falling within the scope of a 4xxx aluminum alloy, as defined in the Teal Sheets. A 4xxx aluminum alloy is an aluminum alloy comprising silicon (Si) as the predominate alloying ingredient, except for aluminum, optionally comprising tolerable levels of oxygen (e.g., from about 0.01 to 0.20 wt. % O) therein due to normal additive manufacturing processes. The 4xxx aluminum alloy compositions include the 3xx alloy compositions and the 4xx alloy compositions of the Pink Sheets. Also, as used herein, the term “4xxx aluminum alloy” only refers to the composition and not any associated processing, i.e., as used herein a 4xxx aluminum alloy product does not need to be a wrought product to be considered a 4xxx aluminum alloy composition/product described herein.

In one embodiment, a metal particle consists of a composition consisting with a 5xxx aluminum alloy, as defined in the Teal Sheets. A 5xxx aluminum alloy is an aluminum alloy comprising magnesium (Mg) as the predominate alloying ingredient, except for aluminum, optionally comprising tolerable levels of oxygen (e.g., from about 0.01 to 0.20 wt. % O) therein due to normal additive manufacturing processes. The 5xxx aluminum alloy compositions include the 5xx alloy compositions of the Pink Sheets. Also, as used herein, the term “5xxx aluminum alloy” only refers to the composition and not any associated processing, i.e., as used herein a 5xxx aluminum alloy product does not need to be a wrought product to be considered a 5xxx aluminum alloy composition/product described herein.

In one embodiment, a metal particle consists of a composition falling within the scope of a 6xxx aluminum alloy, as defined in the Teal Sheets. A 6xxx aluminum alloy is an aluminum alloy comprising both silicon and magnesium, and in amounts sufficient to form the precipitate Mg₂Si, optionally comprising tolerable levels of oxygen (e.g., from about 0.01 to 0.20 wt. % O) therein due to normal additive manufacturing processes. Also, as used herein, the term “6xxx aluminum alloy” only refers to the composition and not any associated processing, i.e., as used herein a 6xxx aluminum alloy product does not need to be a wrought product to be considered a 6xxx aluminum alloy composition/product described herein.

In one embodiment, a metal particle consists of a composition falling within the scope of a 7xxx aluminum alloy, as defined in the Teal Sheets. A 7xxx aluminum alloy is an aluminum alloy comprising zinc (Zn) as the predominate alloying ingredient, except for aluminum, optionally comprising tolerable levels of oxygen (e.g., from about 0.01 to 0.20 wt. % O) therein due to normal additive manufacturing processes. The 7xxx aluminum alloy compositions include the 7xx alloy compositions of the Pink Sheets. Also, as used herein, the term “7xxx aluminum alloy” only refers to the composition and not any associated processing, i.e., as used herein a 7xxx aluminum alloy product does not need to be a wrought product to be considered a 7xxx aluminum alloy composition/product described herein.

In one embodiment, a metal particle consists of a composition falling within the scope of a 8xxx aluminum alloy, as defined in the Teal Sheets. A 8xxx aluminum alloy is any aluminum alloy that is not a 1xxx-7xxx aluminum alloy. Examples of 8xxx aluminum alloys include alloys having iron or lithium as the predominate alloying element, other than aluminum, optionally comprising tolerable levels of oxygen (e.g., from about 0.01 to 0.20 wt. % O) therein due to normal additive manufacturing processes. The 8xxx aluminum alloy compositions include the 8xx alloy compositions and 9xx alloy compositions of the Pink Sheets. As noted in ANSI H35.1 (2009), referenced by the Pink Sheets, the 9xx alloy compositions are aluminum alloys with “other elements” other than copper, silicon, magnesium, zinc, and tin, as the major alloying element. Also, as used herein, the term “8xxx aluminum alloy” only refers to the composition and not any associated processing, i.e., as used herein an 8xxx aluminum alloy product does not need to be a wrought product to be considered an 8xxx aluminum alloy composition/product described herein.

As used herein, “ceramic-metal particle” means a particle having at least one ceramic phase and at least one metal phase. As used herein, a “ceramic phase” means a phase consisting essentially of a ceramic. As used herein, a “metal phase” means a phase consisting essentially of at least one metal, wherein the metal may be in metallic or alloyed form. For instance, a ceramic-metal particle may include both a TiB₂ phase and an aluminum phase (e.g., metallic aluminum, an aluminum alloy). Multiple metals and/or multiple ceramics may be included in a ceramic-metal particle to produce multiple ceramic phase(s) and/or metal phase(s).

As used herein, “other particle” means any particle that is not a ceramic particle, a metal particle or a ceramic-metal particle. Examples of “other particles” include carbon-based polymer particles (e.g., short or long chained hydrocarbons (branched or unbranched)), carbon nanotube particles, and graphene particles, among others.

As noted above, additive manufacturing may be used to create, layer-by-layer, an aluminum alloy product. In one embodiment, a powder bed is used to create an aluminum alloy product (e.g., a tailored aluminum alloy product). As used herein a “powder bed” means a bed comprising a powder. During additive manufacturing, particles of different compositions may melt (e.g., rapidly melt) and then solidify (e.g., in the absence of homogenous mixing). Thus, aluminum alloy products having a homogenous or non-homogeneous microstructure may be produced, which aluminum alloy products cannot be achieved via conventional shape casting or wrought product production methods.

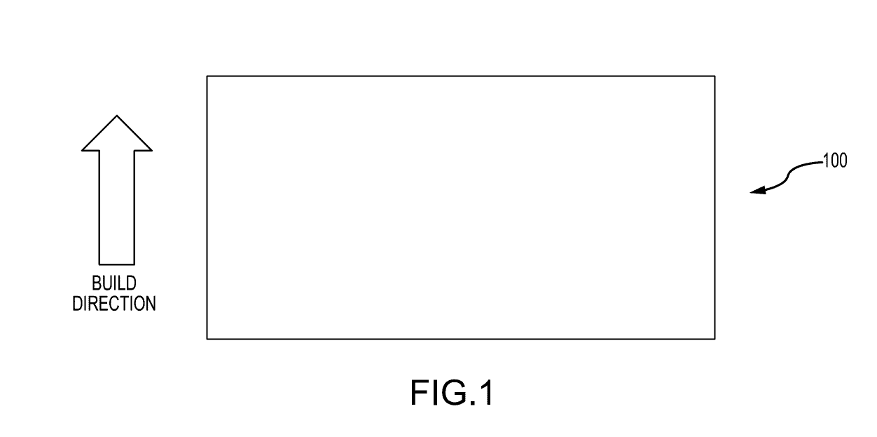

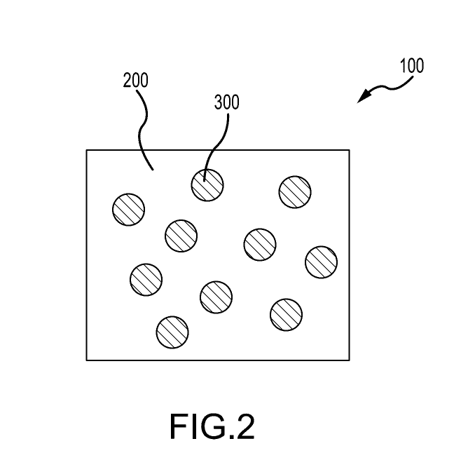

In one embodiment, the same general powder is used throughout the additive manufacturing process to produce an aluminum alloy product. For instance, and referring now to FIG. 1, a final tailored aluminum alloy product (100) may comprise a single region produced by using generally the same powder during the additive manufacturing process. As one specific example, and with reference now to FIG. 2, the single powder may include a blend of ceramic particles (e.g., TiB₂ particles) and (b) metal particles (e.g., aluminum alloy particles). As another specific example, the single powder may include ceramic-metal particles (e.g., TiB₂-aluminum alloy particles). The single powder or single powder blend may be used to produce an aluminum alloy product having a large volume of a first region (200) and smaller volume of a second region (300). For instance, the first region (200) may comprise an aluminum alloy region (e.g., due to the metal particles), and the second region (300) may comprise a ceramic region (e.g., due to the ceramic particles). The product may realize, for instance, higher stiffness and/or higher strength due to the ceramic region (300). Similar results may be realized using a single powder comprising ceramic-metal particles. In another embodiment, the single powder may be ceramic-metal particles having a ceramic material dispersed within an aluminum material (e.g., within metallic aluminum or an aluminum alloy). The first region (200) may comprise metallic aluminum region or an aluminum alloy region (e.g., due to the metallic aluminum or aluminum alloy of the ceramic-metal particles), and the second region (300) may comprise a ceramic region (e.g., due to the ceramic material of the ceramic-metal particles). In one embodiment, the aluminum alloy product comprises a homogenous distribution of the ceramic phases within the metallic aluminum matrix or aluminum alloy matrix. In this regard, at least some of the ceramic-metal particles may comprise a homogenous distribution of the ceramic material within the aluminum material of the ceramic-metal particles.

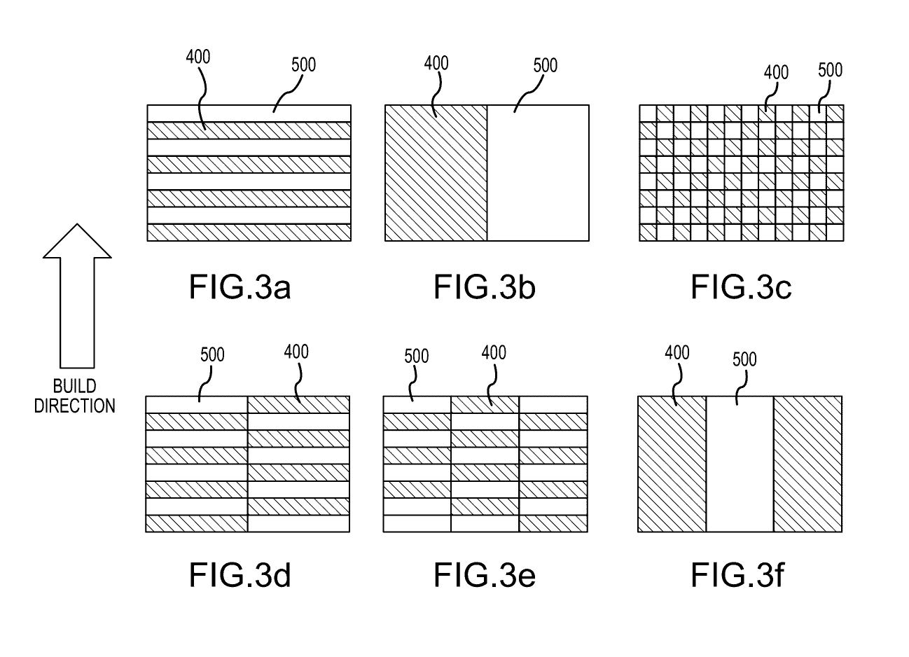

In another embodiment, different powder bed types may be used to produce an aluminum alloy product. For instance, a first powder bed may comprise a first powder and a second powder bed may comprise a second powder, different than the first powder. The first powder bed may be used to produce a first layer or portion of an aluminum alloy product, and the second powder bed may be used to produce a second layer or portion of the aluminum alloy product. For instance, and with reference now to FIGS. 3a-3f, a first region (400) and a second region (500), may be present. To produce the first region (400), a first powder bed may be used, and the first powder bed may comprise a first powder consisting essentially of metal particles. To produce the second region (500), a second powder bed may comprise a second powder of a blend of metal particles and ceramic particles, or ceramic-metal particles. Third distinct regions, fourth distinct regions, and so on can be produced using additional powders and layers. Thus, the overall composition and/or physical properties of the powder during the additive manufacturing process may be pre-selected, resulting in tailored aluminum alloy products having tailored regions therein.

As used herein, a “particle” means a minute fragment of matter having a size suitable for use in the powder of the powder bed (e.g., a size of from 5 microns to 100 microns). Particles may be produced, for example, via gas atomization. For instance, ceramic-metal particles may be produced by casting a ceramic-metal ingot, and then subsequently atomizing the materials of the ceramic-metal ingot into ceramic-metal particles. As used herein, a “ceramic-metal ingot” is an ingot having at least one metal phase and at least one ceramic phase, wherein the at least one ceramic phase makes-up 1-30 vol. % of the ceramic-metal ingot. The ceramic-metal ingot may be subsequently heated to liquefy the metal phase, thereby creating a (liquid metal)-(solid ceramic) mixture (e.g., a suspension, a colloid). This mixture may be homogeneously maintained (e.g., by stirring) and then atomized to produce ceramic-metal particles. Metal particles may be produced in a similar fashion. Ceramic particles and/or other particles may be produced by carbothermal reduction, chemical vapor deposition, or and other thermal-chemical production processes known to those skilled in the art.

In one embodiment, a powder realizes a median (D₅₀) volume weighted particle size distribution of from 10 micron to 105 microns, depending on the type of manufacturing device that is used. In one embodiment, a powder realizes a median (D₅₀) volume weighted particle size distribution of not greater than 95 microns. In one embodiment, a powder realizes a median (D₅₀) volume weighted particle size distribution of not greater than 85 microns. In one embodiment, a powder realizes a median (D₅₀) volume weighted particle size distribution of not greater than 75 microns. In one embodiment, a powder realizes a median (D₅₀) volume weighted particle size distribution of at least 15 microns. In one embodiment, a powder realizes a median (D₅₀) volume weighted particle size distribution of at least 20 microns. In one embodiment, a powder realizes a median (D₅₀) volume weighted particle size distribution of at least 25 microns. In one embodiment, a powder realizes a median (D₅₀) volume weighted particle size distribution of at least 30 microns. In one embodiment, a powder realizes a median (D₅₀) volume weighted particle size distribution of from 20 to 60 microns. In one embodiment, a powder realizes a median (D₅₀) volume weighted particle size distribution of from 30 to 50 microns.

As noted above, the aluminum alloy product generally includes 1-30 vol. % ceramic phase. In one embodiment, the ceramic phase makes up 1-25 vol. % of the aluminum alloy product. In another embodiment, the ceramic phase makes up 1-20 vol. % of the aluminum alloy product. In yet another embodiment, the ceramic phase makes up 1-15 vol. % of the aluminum alloy product. In another embodiment, the ceramic phase makes up 1-10 vol. % of the aluminum alloy product. In yet another embodiment, the ceramic phase makes up 5-10 vol. % of the aluminum alloy product. In yet another embodiment, the ceramic phase makes up 1.5-5.0 vol. % of the aluminum alloy product. In another embodiment, the ceramic phase makes up 1.5-4.0 vol. % of the aluminum alloy product. In yet another embodiment, the ceramic phase makes up 1.5-3.0 vol. % of the aluminum alloy product.

In one aspect, the aluminum alloy is a 2xxx aluminum alloy, and the aluminum alloy product is a 2xxx aluminum alloy product comprising 1-30 vol. % ceramic phase. In one embodiment, the 2xxx aluminum alloy product comprises one of 2519, 2040, 2219, 2618, 2024, 2124, 2224, 2324, 2524, 2624, 2724, 2099, 2199, 2055, 2060, 2070, 2198, 2196, 2050, 2027, 2026, 2029, and 2014 (as defined by the Teal Sheets) as the aluminum alloy, and comprises 1-30 vol. % ceramic phase, and optionally comprises tolerable levels of oxygen (e.g., from about 0.01 to 0.20 wt. % O) therein due to normal additive manufacturing processes.

In one approach, the aluminum alloy product is a 2519 aluminum alloy product comprising 1-30 vol. % of a ceramic phase (e.g., 1.5-5.0 vol. %), wherein the ceramic phase consists essentially of TiB₂, TiC, or mixtures thereof, optionally comprising tolerable levels of oxygen (e.g., from about 0.01 to 0.20 wt. % O) therein due to normal additive manufacturing processes. As shown in the Teal Sheets, AA2519 includes 5.3-6.4 wt. % Cu, 0.10-0.50 wt. % Mn, 0.05-0.40 wt. % Mg, 0.02-0.10 wt. % Ti, 0.05-0.15 wt. % V, 0.10-0.25 wt. % Zr, not greater than 0.25 wt. % Si as an impurity, not greater than 0.30 wt. % Fe as an impurity, where wt. % Si plus wt. % Fe is not greater than 0.40 wt. %, and not greater than 0.10 wt. % Zn as an impurity, the balance being aluminum and other unavoidable impurities. An aluminum alloy 2519 product with 1-30 vol. % of ceramic phase therein may be useful in elevated temperature applications (e.g., due to its thermal stability). In one embodiment, the 2519 aluminum alloy product comprises 1-25 vol. % of the TiB₂, TiC, or mixtures thereof. In another embodiment, the 2519 aluminum alloy product comprises 1-20 vol. % of the TiB₂, TiC, or mixtures thereof. In yet another embodiment, the 2519 aluminum alloy product comprises 1-15 vol. % of the TiB₂, TiC, or mixtures thereof. In another embodiment, the 2519 aluminum alloy product comprises 1-10 vol. % of the TiB₂, TiC, or mixtures thereof. In yet another embodiment, the 2519 aluminum alloy product comprises 1.5-5 vol. % of the TiB₂, TiC, or mixtures thereof. In yet another embodiment, the 2519 aluminum alloy product comprises 1.5-4 vol. % of the TiB₂, TiC, or mixtures thereof. In yet another embodiment, the 2519 aluminum alloy product comprises 1.5-3 vol. % of the TiB₂, TiC, or mixtures thereof. In yet another embodiment, the 2519 aluminum alloy product comprises 5-10 vol. % of the TiB₂, TiC, or mixtures thereof.

In another aspect, the aluminum alloy is an 8xxx aluminum alloy, and the aluminum alloy product is a 8xxx aluminum alloy product comprising 1-30 vol. % ceramic phase. In one approach, the 8xxx aluminum alloy product is 8009 or 8019 (as defined by the Teal Sheets) as the aluminum alloy, and comprises 1-30 vol. % ceramic phase (e.g., 1.5-5.0 vol. %), and optionally comprises tolerable levels of oxygen (e.g., from about 0.01 to 0.20 wt. % O) therein due to normal additive manufacturing processes. As shown in the Teal Sheets, AA8009 includes 8.4-8.9 wt. % Fe, 1.7-1.9 wt. % Si, 1.1-1.5 wt. % V, up to 0.10 wt. % Ti, not greater than 0.10 wt. % Mn as an impurity, not greater than 0.10 wt. % Cr as an impurity, not greater than 0.25 wt. % Zn as an impurity, not greater than 0.30 wt. % O as an impurity, the balance being aluminum and other unavoidable impurities. As shown in the Teal Sheets, AA8019 includes 7.3-9.3 wt. % Fe, 3.5-4.5 wt. % Ce, 0.05-0.50 wt. % O, up to up to 0.05 wt. % Ti, not greater than 0.20 wt. % Si as an impurity, not greater than 0.05 wt. % Mn as an impurity, not greater than 0.05 wt. % Zn as an impurity, the balance being aluminum and other unavoidable impurities. An aluminum alloy 8009 or 8019 product with 1-30 vol. % of ceramic phase therein may be useful in elevated temperature applications (e.g., due to its thermal stability). In one embodiment, the 8009 or 8019 aluminum alloy product comprises 1-25 vol. % of the TiB₂, TiC, or mixtures thereof. In another embodiment, the 8009 or 8019 aluminum alloy product comprises 1-20 vol. % of the TiB₂, TiC, or mixtures thereof. In yet another embodiment, the 8009 or 8019 aluminum alloy product comprises 1-15 vol. % of the TiB₂, TiC, or mixtures thereof. In another embodiment, the 8009 or 8019 aluminum alloy product comprises 1-10 vol. % of the TiB₂, TiC, or mixtures thereof. In yet another embodiment, the 8009 or 8019 aluminum alloy product comprises 1.5-5 vol. % of the TiB₂, TiC, or mixtures thereof. In yet another embodiment, the 8009 or 8019 aluminum alloy product comprises 1.5-4 vol. % of the TiB₂, TiC, or mixtures thereof. In yet another embodiment, the 8009 or 8019 aluminum alloy product comprises 1.5-3 vol. % of the TiB₂, TiC, or mixtures thereof. In yet another embodiment, the 8009 or 8019 aluminum alloy product comprises 5-10 vol. % of the TiB₂, TiC, or mixtures thereof.

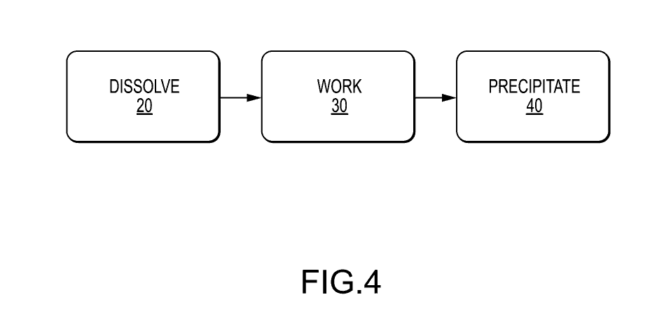

Referring now to FIG. 4, the additively manufactured product may be subject to any appropriate dissolving (20), working (30) and/or precipitation hardening steps (40). If employed, the dissolving (20) and/or the working (30) steps may be conducted on an intermediate form of the additively manufactured body and/or may be conducted on a final form of the additively manufactured body. If employed, the precipitation hardening step (40) is generally conducted relative to the final form of the additively manufactured body.

With continued reference to FIG. 4, the method may include one or more dissolving steps (20), where an intermediate product form and/or the final product form are heated above a solvus temperature of the product but below the solidus temperature of the material, thereby dissolving at least some of the undissolved particles. The dissolving step (20) may include soaking the material for a time sufficient to dissolve the applicable particles. In one embodiment, a dissolving step (20) may be considered a homogenization step. After the soak, the material may be cooled to ambient temperature for subsequent working. Alternatively, after the soak, the material may be immediately hot worked via the working step (30).

When employed, the working step (30) generally involves hot working and/or cold working an intermediate product form. The hot working and/or cold working may include rolling, extrusion or forging of the material, for instance. The working (30) may occur before and/or after any dissolving step (20). For instance, after the conclusion of a dissolving step (20), the material may be allowed to cool to ambient temperature, and then reheated to an appropriate temperature for hot working. Alternatively, the material may be cold worked at around ambient temperatures. In some embodiments, the material may be hot worked, cooled to ambient, and then cold worked. In yet other embodiments, the hot working may commence after a soak of a dissolving step (20) so that reheating of the product is not required for hot working.

The working step (30) may result in precipitation of second phase particles. In this regard, any number of post-working dissolving steps (20) can be utilized, as appropriate, to dissolve at least some of the undissolved second phase particles that may have formed due to the working step (30).

After any appropriate dissolving (20) and working (30) steps, the final product form may be precipitation hardened (40). The precipitation hardening (40) may include heating the final product form above a solvus temperature for a time sufficient to dissolve at least some particles precipitated due to the working, and then rapidly cooling the final product form. The precipitation hardening (40) may further include subjecting the product to a target temperature for a time sufficient to form precipitates (e.g., strengthening precipitates), and then cooling the product to ambient temperature, thereby realizing a final aged product having desired precipitates therein. As may be appreciated, at least some working (30) of the product may be completed after a precipitating (40) step. In one embodiment, a final aged product contains ≧0.5 vol. % of the desired precipitates (e.g., strengthening precipitates) and ≦0.5 vol. % of coarse second phase particles.

After or during production, an additively manufactured product may be deformed (e.g., by one or more of rolling, extruding, forging, stretching, compressing). The final deformed product may realize, for instance, improved properties due to the tailored regions and thermo-mechanical processing of the final deformed aluminum alloy product. Thus, in some embodiments, the final product is a wrought aluminum alloy product, the word “wrought” referring to the working (hot working and/or cold working) of the additively manufactured product, wherein the working occurs relative to an intermediate and/or final form of the additively manufactured product. In other approaches, the final product is a non-wrought product, i.e., is not worked during or after the additive manufacturing process. In these non-wrought product embodiments, any appropriate number of dissolving (20) and (40) precipitating steps may still be utilized. For instance, a 2xxx aluminum alloy product having 1-30 vol. % ceramic phase therein (e.g., 2519+1-30 vol. % TiB₂) may be additively manufactured and then subject to an appropriate dissolving (20) and/or precipitating step (40) to facilitate age hardening of the non-wrought 2xxx aluminum alloy product.

In one embodiment, the final product is a metallic aluminum alloy product, wherein the metallic aluminum alloy product comprises one or more ceramic phases, and wherein the metallic aluminum alloy product comprises 1-30 vol. % of the one or more ceramic phases. In one embodiment, the final product is a non-wrought metallic aluminum alloy product (i.e., is not worked after completion of the additive manufacturing process), wherein the non-wrought metallic aluminum alloy product comprises one or more ceramic phases, and wherein the non-wrought metallic aluminum alloy product comprises 1-30 vol. % of the one or more ceramic phases. In another embodiment, the final product is a wrought metallic aluminum alloy product (i.e., is worked after completion of the additive manufacturing process), wherein the wrought metallic aluminum alloy product comprises one or more ceramic phases, and wherein the wrought aluminum alloy product comprises 1-30 vol. % of the one or more ceramic phases. In some embodiments, the metallic aluminum alloy product (wrought or non-wrought) may comprise a homogenous distribution of the at least one or more ceramic phases within the metallic aluminum alloy (e.g., as shown in FIG. 1). In other embodiments, the metallic aluminum alloy product (wrought or non-wrought) may comprise tailored regions of non-uniformity (e.g., as shown in FIGS. 2 and 3a-3f).

In one embodiment, the final product is a 2xxx aluminum alloy product, wherein the 2xxx aluminum alloy product comprises one or more ceramic phases, and wherein the 2xxx aluminum alloy product comprises 1-30 vol. % of the one or more ceramic phases. In one embodiment, the final product is a non-wrought 2xxx aluminum alloy product (i.e., is not worked during, or after completion of, the additive manufacturing process), wherein the non-wrought 2xxx aluminum alloy product comprises one or more ceramic phases, and wherein the non-wrought 2xxx aluminum alloy product comprises 1-30 vol. % of the one or more ceramic phases. In another embodiment, the final product is a wrought 2xxx aluminum alloy product (i.e., is worked during and/or after completion of the additive manufacturing process), wherein the wrought 2xxx aluminum alloy product comprises one or more ceramic phases, and wherein the wrought 2xxx aluminum alloy product comprises 1-30 vol. % of the one or more ceramic phases. In some embodiments, the 2xxx aluminum alloy product (wrought or non-wrought) may comprise a homogenous distribution of the at least one or more ceramic phases within the 2xxx aluminum alloy (e.g., as shown in FIG. 1). In other embodiments, the 2xxx aluminum alloy product (wrought or non-wrought) may comprise tailored regions of non-uniformity (e.g., as shown in FIGS. 2 and 3a-3f).

In one embodiment, the final product is a 3xxx aluminum alloy product, wherein the 3xxx aluminum alloy product comprises one or more ceramic phases, and wherein the 3xxx aluminum alloy product comprises 1-30 vol. % of the one or more ceramic phases. In one embodiment, the final product is a non-wrought 3xxx aluminum alloy product (i.e., is not worked during, or after completion of, the additive manufacturing process), wherein the non-wrought 3xxx aluminum alloy product comprises one or more ceramic phases, and wherein the non-wrought 3xxx aluminum alloy product comprises 1-30 vol. % of the one or more ceramic phases. In another embodiment, the final product is a wrought 3xxx aluminum alloy product (i.e., is worked during and/or after completion of the additive manufacturing process), wherein the wrought 3xxx aluminum alloy product comprises one or more ceramic phases, and wherein the wrought 3xxx aluminum alloy product comprises 1-30 vol. % of the one or more ceramic phases. In some embodiments, the 3xxx aluminum alloy product (wrought or non-wrought) may comprise a homogenous distribution of the at least one or more ceramic phases within the 3xxx aluminum alloy (e.g., as shown in FIG. 1). In other embodiments, the 3xxx aluminum alloy product (wrought or non-wrought) may comprise tailored regions of non-uniformity (e.g., as shown in FIGS. 2 and 3a-3f).

In one embodiment, the final product is a 4xxx aluminum alloy product, wherein the 4xxx aluminum alloy product comprises one or more ceramic phases, and wherein the 4xxx aluminum alloy product comprises 1-30 vol. % of the one or more ceramic phases. In one embodiment, the final product is a non-wrought 4xxx aluminum alloy product (i.e., is not worked during, or after completion of, the additive manufacturing process), wherein the non-wrought 4xxx aluminum alloy product comprises one or more ceramic phases, and wherein the non-wrought 4xxx aluminum alloy product comprises 1-30 vol. % of the one or more ceramic phases. In another embodiment, the final product is a wrought 4xxx aluminum alloy product (i.e., is worked during and/or after completion of the additive manufacturing process), wherein the wrought 4xxx aluminum alloy product comprises one or more ceramic phases, and wherein the wrought 4xxx aluminum alloy product comprises 1-30 vol. % of the one or more ceramic phases. In some embodiments, the 4xxx aluminum alloy product (wrought or non-wrought) may comprise a homogenous distribution of the at least one or more ceramic phases within the 4xxx aluminum alloy (e.g., as shown in FIG. 1). In other embodiments, the 4xxx aluminum alloy product (wrought or non-wrought) may comprise tailored regions of non-uniformity (e.g., as shown in FIGS. 2 and 3a-3f).

In one embodiment, the final product is a 5xxx aluminum alloy product, wherein the 5xxx aluminum alloy product comprises one or more ceramic phases, and wherein the 5xxx aluminum alloy product comprises 1-30 vol. % of the one or more ceramic phases. In one embodiment, the final product is a non-wrought 5xxx aluminum alloy product (i.e., is not worked during, or after completion of, the additive manufacturing process), wherein the non-wrought 5xxx aluminum alloy product comprises one or more ceramic phases, and wherein the non-wrought 5xxx aluminum alloy product comprises 1-30 vol. % of the one or more ceramic phases. In another embodiment, the final product is a wrought 5xxx aluminum alloy product (i.e., is worked during and/or after completion of the additive manufacturing process), wherein the wrought 5xxx aluminum alloy product comprises one or more ceramic phases, and wherein the wrought 5xxx aluminum alloy product comprises 1-30 vol. % of the one or more ceramic phases. In some embodiments, the 5xxx aluminum alloy product (wrought or non-wrought) may comprise a homogenous distribution of the at least one or more ceramic phases within the 5xxx aluminum alloy (e.g., as shown in FIG. 1). In other embodiments, the 5xxx aluminum alloy product (wrought or non-wrought) may comprise tailored regions of non-uniformity (e.g., as shown in FIGS. 2 and 3a-3f).

In one embodiment, the final product is a 6xxx aluminum alloy product, wherein the 6xxx aluminum alloy product comprises one or more ceramic phases, and wherein the 6xxx aluminum alloy product comprises 1-30 vol. % of the one or more ceramic phases. In one embodiment, the final product is a non-wrought 6xxx aluminum alloy product (i.e., is not worked during, or after completion of, the additive manufacturing process), wherein the non-wrought 6xxx aluminum alloy product comprises one or more ceramic phases, and wherein the non-wrought 6xxx aluminum alloy product comprises 1-30 vol. % of the one or more ceramic phases. In another embodiment, the final product is a wrought 6xxx aluminum alloy product (i.e., is worked during and/or after completion of the additive manufacturing process), wherein the wrought 6xxx aluminum alloy product comprises one or more ceramic phases, and wherein the wrought 6xxx aluminum alloy product comprises 1-30 vol. % of the one or more ceramic phases. In some embodiments, the 6xxx aluminum alloy product (wrought or non-wrought) may comprise a homogenous distribution of the at least one or more ceramic phases within the 6xxx aluminum alloy (e.g., as shown in FIG. 1). In other embodiments, the 6xxx aluminum alloy product (wrought or non-wrought) may comprise tailored regions of non-uniformity (e.g., as shown in FIGS. 2 and 3a-3f).

In one embodiment, the final product is a 7xxx aluminum alloy product, wherein the 7xxx aluminum alloy product comprises one or more ceramic phases, and wherein the 7xxx aluminum alloy product comprises 1-30 vol. % of the one or more ceramic phases. In one embodiment, the final product is a non-wrought 7xxx aluminum alloy product (i.e., is not worked during, or after completion of, the additive manufacturing process), wherein the non-wrought 7xxx aluminum alloy product comprises one or more ceramic phases, and wherein the non-wrought 7xxx aluminum alloy product comprises 1-30 vol. % of the one or more ceramic phases. In another embodiment, the final product is a wrought 7xxx aluminum alloy product (i.e., is worked during and/or after completion of the additive manufacturing process), wherein the wrought 7xxx aluminum alloy product comprises one or more ceramic phases, and wherein the wrought 7xxx aluminum alloy product comprises 1-30 vol. % of the one or more ceramic phases. In some embodiments, the 7xxx aluminum alloy product (wrought or non-wrought) may comprise a homogenous distribution of the at least one or more ceramic phases within the 7xxx aluminum alloy (e.g., as shown in FIG. 1). In other embodiments, the 7xxx aluminum alloy product (wrought or non-wrought) may comprise tailored regions of non-uniformity (e.g., as shown in FIGS. 2 and 3a-3f).

In one embodiment, the final product is a 8xxx aluminum alloy product, wherein the 8xxx aluminum alloy product comprises one or more ceramic phases, and wherein the 8xxx aluminum alloy product comprises 1-30 vol. % of the one or more ceramic phases. In one embodiment, the final product is a non-wrought 8xxx aluminum alloy product (i.e., is not worked during, or after completion of, the additive manufacturing process), wherein the non-wrought 8xxx aluminum alloy product comprises one or more ceramic phases, and wherein the non-wrought 8xxx aluminum alloy product comprises 1-30 vol. % of the one or more ceramic phases. In another embodiment, the final product is a wrought 8xxx aluminum alloy product (i.e., is worked during and/or after completion of the additive manufacturing process), wherein the wrought 8xxx aluminum alloy product comprises one or more ceramic phases, and wherein the wrought 8xxx aluminum alloy product comprises 1-30 vol. % of the one or more ceramic phases. In some embodiments, the 8xxx aluminum alloy product (wrought or non-wrought) may comprise a homogenous distribution of the at least one or more ceramic phases within the 8xxx aluminum alloy (e.g., as shown in FIG. 1). In other embodiments, the 8xxx aluminum alloy product (wrought or non-wrought) may comprise tailored regions of non-uniformity (e.g., as shown in FIGS. 2 and 3a-3f).

In some embodiments, the additively-manufactured product comprises a fine cellular structure (e.g., in the as-built condition, wherein “as-built” refers to the completion of the additive manufacturing portion of the manufacturing processes). A fine cellular structure is a cellular structure (e.g., primary dendrites) having an average size of from 0.1 to 5 microns, as determined by the linear intercept method described in ASTM standard E112-13, entitled “Standard Test Methods for Determining Average Grain Size”. In one embodiment, the maximum size of any portion of the cellular structure is 50 microns, as determined by the linear intercept method. This fine cellular structure may be realized when using metallic aluminum or any of the 2xxx-8xxx aluminum alloys, described above.

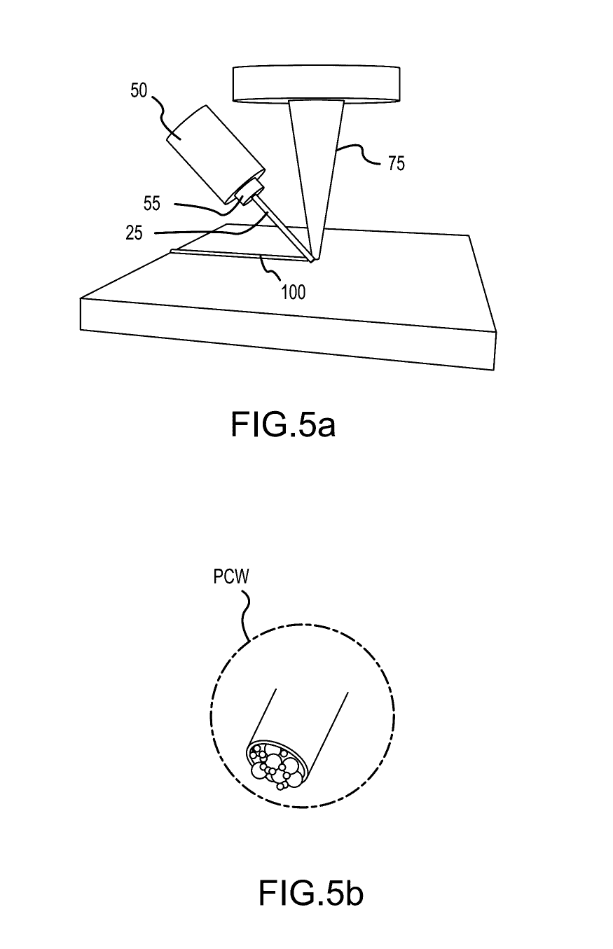

In one approach, electron beam (EB) or plasma arc techniques are utilized to produce at least a portion of the additively manufactured aluminum alloy body. Electron beam techniques may facilitate production of larger parts than readily produced via laser additive manufacturing techniques. For instance, and with reference now to FIG. 5a, in one embodiment, a method comprises feeding a small diameter wire (W) (e.g., a tube ≦2.54 mm in diameter) to the wire feeder portion of an electron beam gun (G). The wire (W) may be of the compositions, described above, provided it is a drawable composition (e.g., when produced per the process conditions of U.S. Pat. No. 5,286,577), or the wire is producible via powder conform extrusion, for instance (e.g., as per U.S. Pat. No. 5,284,428). The electron beam (EB) heats the wire or tube, as the case may be, above the liquidus point of the aluminum alloy to be formed, followed by rapid solidification of the molten pool to form the deposited material (DM).

In one embodiment, and referring now to FIG. 5b, the wire (25) is a powder cored wire (PCW), where a tube portion of the wire contains a volume of the particles therein, such as any of the particles described above (ceramic particles, ceramic-metal particles, metal particles, other particles, and combinations thereof), while the tube itself may comprise aluminum or an aluminum alloy (e.g., a suitable 1xxx-8xxx aluminum alloy). The composition of the volume of particles within the tube may be adapted to account for the amount of aluminum in the tube so as to realize the appropriate end composition. The volume of particles within the tube generally comprises at least some ceramic particles, ceramic-metal particles, and combinations thereof so as to facilitate production of the 1-30 vol. % ceramic phase within the aluminum-based product.

In one embodiment, the tube is metallic aluminum and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is metallic aluminum and the particles comprise ceramic particles. In one embodiment, the tube is metallic aluminum and the particles comprise ceramic-metal particles. In one embodiment, the tube is metallic aluminum and the particles comprise both ceramic particles and ceramic-metal particles. In one embodiment, the tube is metallic aluminum and the particles comprise ceramic particles and metal particles. In one embodiment, the tube is metallic aluminum and the particles comprise ceramic-metal particles and metal particles. In one embodiment, the tube is metallic aluminum and the particles comprise ceramic particles, ceramic-metal particles and metal particles.

In one embodiment, the tube is a 2xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is a 2xxx aluminum alloy and the particles comprise ceramic particles. In one embodiment, the tube is a 2xxx aluminum alloy and the particles comprise ceramic-metal particles. In one embodiment, the tube is a 2xxx aluminum alloy and the particles comprise both ceramic particles and ceramic-metal particles. In one embodiment, the tube is a 2xxx aluminum alloy and the particles comprise ceramic particles and metal particles. In one embodiment, the tube is a 2xxx aluminum alloy and the particles comprise ceramic-metal particles and metal particles. In one embodiment, the tube is a 2xxx aluminum alloy and the particles comprise ceramic particles, ceramic-metal particles and metal particles.

In one embodiment, the tube is a 3xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is a 3xxx aluminum alloy and the particles comprise ceramic particles. In one embodiment, the tube is a 3xxx aluminum alloy and the particles comprise ceramic-metal particles. In one embodiment, the tube is a 3xxx aluminum alloy and the particles comprise both ceramic particles and ceramic-metal particles. In one embodiment, the tube is a 3xxx aluminum alloy and the particles comprise ceramic particles and metal particles. In one embodiment, the tube is a 3xxx aluminum alloy and the particles comprise ceramic-metal particles and metal particles. In one embodiment, the tube is a 3xxx aluminum alloy and the particles comprise ceramic particles, ceramic-metal particles and metal particles.

In one embodiment, the tube is a 4xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is a 4xxx aluminum alloy and the particles comprise ceramic particles. In one embodiment, the tube is a 4xxx aluminum alloy and the particles comprise ceramic-metal particles. In one embodiment, the tube is a 4xxx aluminum alloy and the particles comprise both ceramic particles and ceramic-metal particles. In one embodiment, the tube is a 4xxx aluminum alloy and the particles comprise ceramic particles and metal particles. In one embodiment, the tube is a 4xxx aluminum alloy and the particles comprise ceramic-metal particles and metal particles. In one embodiment, the tube is a 4xxx aluminum alloy and the particles comprise ceramic particles, ceramic-metal particles and metal particles.

In one embodiment, the tube is a 5xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is a 5xxx aluminum alloy and the particles comprise ceramic particles. In one embodiment, the tube is a 5xxx aluminum alloy and the particles comprise ceramic-metal particles. In one embodiment, the tube is a 5xxx aluminum alloy and the particles comprise both ceramic particles and ceramic-metal particles. In one embodiment, the tube is a 5xxx aluminum alloy and the particles comprise ceramic particles and metal particles. In one embodiment, the tube is a 5xxx aluminum alloy and the particles comprise ceramic-metal particles and metal particles. In one embodiment, the tube is a 5xxx aluminum alloy and the particles comprise ceramic particles, ceramic-metal particles and metal particles.

In one embodiment, the tube is a 6xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is a 6xxx aluminum alloy and the particles comprise ceramic particles. In one embodiment, the tube is a 6xxx aluminum alloy and the particles comprise ceramic-metal particles. In one embodiment, the tube is a 6xxx aluminum alloy and the particles comprise both ceramic particles and ceramic-metal particles. In one embodiment, the tube is a 6xxx aluminum alloy and the particles comprise ceramic particles and metal particles. In one embodiment, the tube is a 6xxx aluminum alloy and the particles comprise ceramic-metal particles and metal particles. In one embodiment, the tube is a 6xxx aluminum alloy and the particles comprise ceramic particles, ceramic-metal particles and metal particles.

In one embodiment, the tube is a 7xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is a 7xxx aluminum alloy and the particles comprise ceramic particles. In one embodiment, the tube is a 7xxx aluminum alloy and the particles comprise ceramic-metal particles. In one embodiment, the tube is a 7xxx aluminum alloy and the particles comprise both ceramic particles and ceramic-metal particles. In one embodiment, the tube is a 7xxx aluminum alloy and the particles comprise ceramic particles and metal particles. In one embodiment, the tube is a 7xxx aluminum alloy and the particles comprise ceramic-metal particles and metal particles. In one embodiment, the tube is a 7xxx aluminum alloy and the particles comprise ceramic particles, ceramic-metal particles and metal particles.

In one embodiment, the tube is an 8xxx aluminum alloy and the particles held within the tube, as shown in FIG. 5b, are selected from the group consisting of ceramic-metal particles, ceramic particles, metal particles, other particles, and combinations thereof, wherein at least some ceramic particles, ceramic-metal particles, and combinations thereof are present. In one embodiment, the tube is an 8xxx aluminum alloy and the particles comprise ceramic particles. In one embodiment, the tube is an 8xxx aluminum alloy and the particles comprise ceramic-metal particles. In one embodiment, the tube is an 8xxx aluminum alloy and the particles comprise both ceramic particles and ceramic-metal particles. In one embodiment, the tube is an 8xxx aluminum alloy and the particles comprise ceramic particles and metal particles. In one embodiment, the tube is an 8xxx aluminum alloy and the particles comprise ceramic-metal particles and metal particles. In one embodiment, the tube is an 8xxx aluminum alloy and the particles comprise ceramic particles, ceramic-metal particles and metal particles.

The new aluminum products described herein may be used in a variety of product applications. In one embodiment, the new aluminum products are utilized in an elevated temperature application, such as in an aerospace or automotive vehicle. In one embodiment, a new aluminum product is utilized as an engine component in an aerospace vehicle (e.g., in the form of a blade, such as a compressor blade incorporated into the engine). In another embodiment, the new aluminum product is used as a heat exchanger for the engine of the aerospace vehicle. The aerospace vehicle including the engine component/heat exchanger may subsequently be operated. In one embodiment, a new aluminum product is an automotive engine component. The automotive vehicle including the engine component may subsequently be operated. For instance, a new aluminum product may be used as a turbo charger component (e.g., a compressor wheel of a turbo charger, where elevated temperatures may be realized due to recycling engine exhaust back through the turbo charger), and the automotive vehicle including the turbo charger component may be operated. In another embodiment, an aluminum product may be used as a blade in a land based (stationary) turbine for electrical power generation, and the land based turbine included the aluminum product may be operated to facilitate electrical power generation.

### Example 1—Production of Aluminum Alloy 2519 Having a Homogenous Distribution of TiB₂

A melt was alloyed to the desired wrought alloy AA2519 composition prior to the addition of three weight percent titanium and one weight percent boron, to produce a metal-matrix-composite (MMC) ingot. The ingot was then used as feedstock within an inert gas atomization process to produce an MMC powder of the AA2519+TiB₂ material. The compositions of the ingot and the atomized powder were measured via inductively couple plasma (ICP), the results of which are provided in Table 1, below.

TABLE 1
Composition of Ingot and Powder (all values in wt. %)

| Product | Si | Fe | Mg | Cu | Mn | Ti | V | B | Zr | Balance |
|---|---|---|---|---|---|---|---|---|---|---|
| Ingot | 0.11 | 0.12 | 0.15 | 5.6 | 0.26 | 2.9 | 0.16 | 0.83 | 0.14 | Al and impurities |
| Powder | 0.15 | 0.16 | 0.10 | 5.6 | 0.28 | 3.0 | 0.15 | 0.79 | 0.14 | Al and impurities |

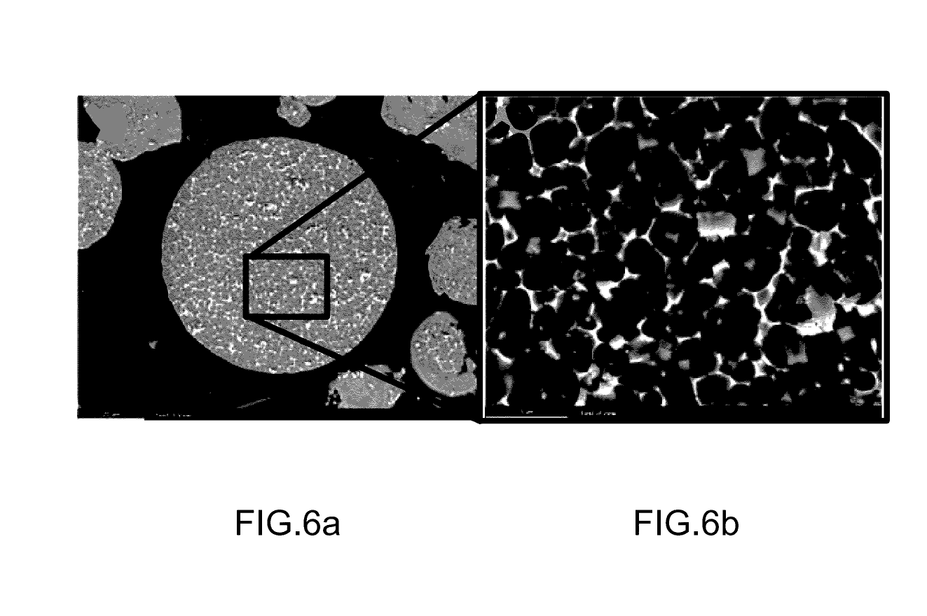

The microstructure of the atomized powders was examined using scanning electron microscopy (SEM). SEM was performed on specimens prepared by mounting powder particles in Bakelite and then grinding and polishing using a combination of polishing media. The SEM performed on cross-sectioned powder particles revealed that each individual powder particle consisted of both an aluminum matrix and a ceramic reinforcement phase, as shown in FIGS. 6(a) and 6(b).

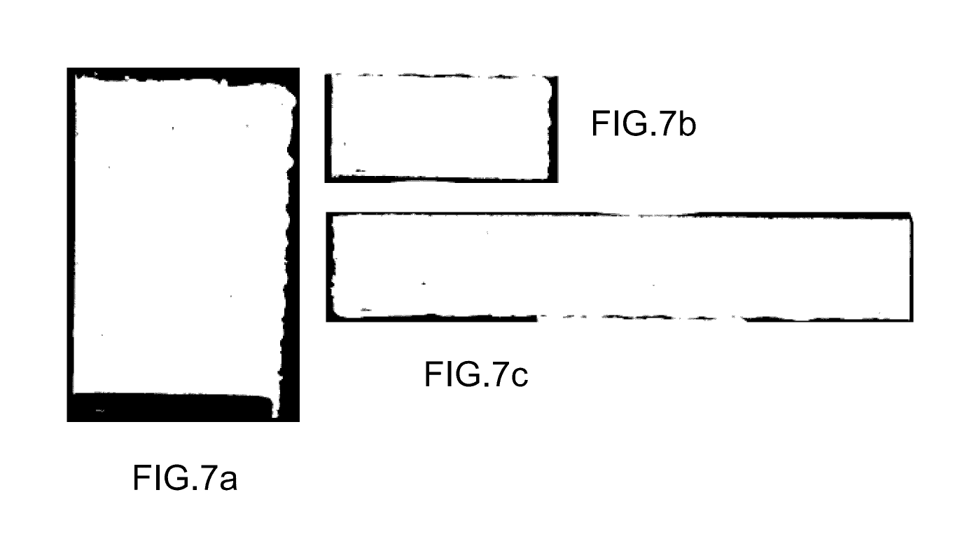

The powder was screened to produce the desired particle size distribution for use within the additive manufacturing process. The median (D₅₀) volume weighted particle size distribution of the powder was 48.81 microns. Several additively manufactured products were prepared from the screened powder using an EOS M280 machine. The bulk density of the as-built components were measured via the Archimedes density method and were determined to generally be >98% of the theoretical density of the alloy. Optical metallography (OM) was performed on an as-built component by mounting the as-built component in Bakelite and then grinding and polishing using a combination of polishing media. FIGS. 7a-7c shows the results, and image analysis run on the as-polished specimen revealed <2% residual porosity within the as-built component, confirming the Archimedes density calculation.

SEM analysis on the as-built components revealed the presence of TiB₂ particles homogenously distributed (not segregated) within the 2519 alloy matrix. Image analysis revealed that the volume area fraction of TiB₂ phase within the as-built components was about 1.6 vol. %.

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

What is claimed is:

1. A method for producing an aluminum-based product, the method comprising:
(a) dispersing a metal powder in a bed, wherein the metal powder comprises ceramic-metal particles, wherein the ceramic-metal particles include a ceramic material dispersed within an aluminum material;
(b) selectively heating a portion of the metal powder to a temperature above the liquidus temperature of the aluminum material;
(c) forming a molten pool; and
(d) cooling the molten pool at a cooling rate of at least 1000° C. per second;
(e) repeating steps (a)-(d) until the aluminum-based product is completed, wherein the aluminum-based product comprises one or more ceramic phases, and wherein the aluminum-based product comprises 1-30 vol. % of the one or more ceramic phases dispersed within an aluminum-based matrix.

2. The method of claim 1, wherein the aluminum material of the ceramic-metal particles is a 2xxx aluminum alloy or an 8xxx aluminum alloy.

3. The method of claim 2, wherein the ceramic material of the ceramic-metal particles is at least one of TiB₂, TiC, SiC, Al₂O₃, BC, BN, and Si₃N₄.

4. The method of claim 2, wherein the ceramic-metal particles consist essentially of the 2xxx or 8xxx aluminum alloy and the ceramic phase.

5. The method of claim 2, wherein the ceramic-metal particles consist essentially of aluminum alloy 2519 and TiB₂.

6. The method of claim 2, wherein the ceramic-metal particles consist essentially of (a) aluminum alloy 8009 or 8019 and (b) TiB₂.

7. The method of claim 2, wherein the ceramic-metal particles comprise a homogenous distribution of the ceramic material within the 2xxx or 8xxx aluminum alloy.

8. The method of claim 1, wherein the aluminum-based product comprises a homogenous distribution of the ceramic phase within a 2xxx or 8xxx aluminum alloy matrix.

9. The method of claim 1, wherein the powder comprises the ceramic-metal particles and further comprises at least one of (i) metal particles and (ii) ceramic particles.

10. A method for producing an aluminum-based product, the method comprising:
(a) dispersing a metal powder in a bed, wherein the metal powder comprises first metal particles and second metal particles, wherein the first metal particles comprise metallic aluminum or an aluminum alloy, and wherein the second metal particles comprise a ceramic;
(b) selectively heating a portion of the metal powder to a temperature above the liquidus temperature of the metallic aluminum or the aluminum alloy;
(c) forming a molten pool; and
(d) cooling the molten pool at a cooling rate of at least 1000° C. per second;
(e) repeating steps (a)-(d) until the aluminum-based product is completed, wherein the aluminum-based product comprises one or more ceramic phases, and wherein the aluminum-based product comprises 1-30 vol. % of the one or more ceramic phases dispersed within an aluminum-based matrix.

11. The method for claim 10, wherein the first metal particles consist essentially of aluminum or an aluminum alloy.

12. The method for claim 11, wherein the second metal particles are selected from the group consisting of ceramic particles, ceramic-metal particles, metal particles, and combinations thereof, wherein at least one of the ceramic particles and the ceramic-metal particles are present in the second metal particles.

13. The method of claim 12, wherein the second metal particles comprise at least one of TiB₂, TiC, SiC, Al₂O₃, BC, BN, and Si₃N₄ ceramic particles.

14. The method of claim 12, wherein the second metal particles are TiB₂ ceramic particles.

15. A method of making an aluminum alloy product, the method comprising:
(a) first producing a first region of an aluminum alloy body via a first metal powder, wherein the first metal powder comprises aluminum;
(i) wherein the first producing step comprises using additive manufacturing to make the first region of the aluminum alloy product;
(b) second producing a second region of an aluminum alloy body via a second metal powder, wherein the first metal powder is different than the second metal powder, and wherein the second metal powder comprises at least one of ceramic particles and ceramic-metal particles;
(i) wherein the second producing step comprises using additive manufacturing to make the second region of the aluminum alloy product;
(ii) wherein the second region is adjacent the first region; and
(iii) wherein the second region comprises one or more ceramic phases, and wherein the second region comprises at least 1 vol. % of the one or more ceramic phases.

16. The method of claim 15, wherein the first region consists essentially of metallic aluminum.

17. The method of claim 15, wherein the first region consists essentially of an aluminum alloy.

18. The method of any of claim 16, wherein the one or more ceramic phases comprise at least one of TiB₂, TiC, SiC, Al₂O₃, BC, BN, and Si₃N₄.

19. The method of any of claim 17, wherein the one or more ceramic phases comprise at least one of TiB₂, TiC, SiC, Al₂O₃, BC, BN, and Si₃N₄.

20. The method of claim 19, wherein the one or more ceramic phases include TiB₂.
